(19) United States
(12) Patent Application Publication
(10) Pub. No.: US 2001/0054010 A1
(43) Pub. Date: Dec. 20, 2001

(54) Electronic redemption system

(76) Inventors: Gregory S. Bernabeo, Strafford, PA (US); Stephen J. Weed, Malvern, PA (US)

Correspondence Address: Gregory S. Bernabeo, Esquire, Synnestvedt & Lechner LLP, 2600 Aramark Tower, 1101 Market Street, Philadelphia, PA, 19107-2950, US

(21) Appl. No.: 09/850,680

(22) Filed: May 7, 2001

Related U.S. Application Data
(60) Provisional application No. 60/202,251, filed on May 5, 2000.

(51) Int. Cl. G06F 17/60

(52) U.S. Cl. 705/26

(57) ABSTRACT

An electronic redemption system for electronic commerce transactions. A purchaser accesses a remotely accessible server via a communications network and purchases or reserves available goods or services through the remotely accessible server. The remotely accessible server responsively generates an electronic redemption code and a corresponding electronic sales code. The electronic redemption code is transmitted to an electronic storage device designated by the purchaser, e.g. a handheld PDA, wireless telephone, laptop PC, etc. The electronic sales code is transmitted to a vendor accessible location. The purchase is completed when the electronic redemption code is transmitted, e.g. via an infrared or other short-range transmitter of the purchaser's electronic storage device, to a receiving device capable of receiving electronic data at a physical location of the vendor, provided it corresponds to a valid electronic sales code. The purchaser then receives the goods and the electronic sales code is marked invalid.

### RELATED APPLICATIONS

This application claims the benefit of U.S. Provisional Patent Application No. 60/202,251 filed May 5, 2000, the disclosure of which is hereby incorporated herein by reference.

### FIELD OF THE INVENTION

The present invention relates generally to electronic commerce and, more particularly, to electronic purchasing systems.

### BACKGROUND OF THE INVENTION

The Internet and World Wide Web (collectively referred to herein as the “Web”) have brought about extensive changes in the way commerce is conducted. Electronic commerce, i.e., commerce conducted via the Web, is becoming increasingly popular. Accordingly, a system and method for facilitating electronic commerce transactions is desirable.

For a typical purchase of goods conducted via the Web, a purchaser supplies a vendor with a credit card number via the vendor's website and the vendor charges the account identified by the credit card number. The purchased goods are then delivered to the purchaser via a delivery agent. Such electronic commerce transactions are hampered by logistical delivery problems, e.g., ensuring that someone is home to sign for the goods at the time of delivery. Also, the use of a delivery agent increases the transaction cost of web based purchases by adding another party to the transaction.

Typical electronic commerce methods are inadequate for time-sensitive transactions due to the length of time between purchase and delivery. For example, such a method is inadequate for the purchase of tickets for events scheduled to occur within a short time period from the time of purchase, e.g., it would not be feasible to purchase tickets via the Web for a movie that was scheduled to begin that evening because such a time frame is inadequate for transaction processing and delivery, e.g., by mailing of the tickets.

Systems for purchasing goods via the Web which do not require delivery of goods via a delivery agent have been developed. However, these systems require cumbersome steps which make them difficult to implement and administer. In one type of system, purchasers agree to a purchase price for goods online via a website using their personal computers. The purchaser then prints a list of the purchased goods and goes to a local cooperating vendor to pick up the goods. This approach is well-suited to perishable or fragile items. The list typically includes a scannable bar code which may be scanned at the vendor. In some instances, the purchaser is required to present a membership card to a store clerk after standing in a line and awaiting a turn at the store's cash register. For example, when the purchaser presents, or swipes through a card reader, his membership card, the purchaser is charged the prices the purchaser agreed to online.

Such a system does not assure the purchaser that the purchased items will be available at the time of pick up. For example, if the purchaser purchased a 15 oz. box of a certain brand of cereal and only a 28 oz. box was available at the vendor, the purchaser would not be able to obtain the 15 oz. box of cereal. Also, this method burdens the purchaser with keeping track of a membership card and a list of goods purchased on the Web, in addition to whatever information the purchaser usually takes to the vendor, e.g., a list of non-Web based goods and coupons. Additionally, such a method not only requires the purchaser to separate those goods purchased via the Web from those not so purchased, but also requires the purchaser to complete at least two purchase transactions at the vendor, one using the membership card, and another for the remainder of the goods using a traditional payment method.

Another system for Web-based commerce which eliminates the use of a delivery agent is “print-at-home” ticketing. For example, etix.com, Inc. of Raleigh, N.C. maintains a website accessible at the time of filing of this application at URL http://www.etix.com. Via this website, consumers can purchase and print concert tickets, gift certificates, vouchers, travel tickets, coupons, movie tickets, sporting event tickets, theme park passes, etc. at home, using their personal computers and printers. Each ticket contains a unique, two dimensional barcode that is verified at the venue. The barcode will only be accepted once for admitting a consumer to the venue. After the first copy of a particular ticket containing the barcode is accepted, all subsequent entry attempts using the same barcode are denied.

A similar system exists for purchasing postage stamps via the Web. For example, Stampmaster, Inc. of Westlake Village, Calif. maintains a website accessible at the time of filing of this application at URL http://www.stamps.com by which a user can obtain software for using his personal computer and printer to print postage directly onto envelopes. The postage includes a bar code which is readable by scanning equipment of the U.S. Postal Service.

All of these systems require the purchaser to have access to a printer of sufficient quality to produce the postage, ticket, and/or receipt; and/or require burdensome steps to complete the purchase transaction. Access to printers is especially inconvenient for purchasers who access the Web using handheld devices, such as a Palm® brand personal digital assistant or a Web-enabled cellular telephones. The use and availability of such devices has recently increased dramatically. These devices offer tremendous convenience to their users. However, these devices are not equipped with equally convenient printers.

In addition, relying on the purchaser's printer presents additional problems such as reprinting tickets which are partially printed due to the purchaser's printer running out of ink during printing and handling tickets which are smudged or unreadable.

Given the short time constraints which cannot be met by conventional delivery methods, the inaccessibility of printers for hand held devices, and the problems which arise from having the purchaser print their own tickets, purchasing methods which are not hindered by these limitations is needed.

### SUMMARY OF THE INVENTION

The present invention relates to electronic purchasing systems. The electronic purchasing system of the present invention facilitates transactions between vendors and purchasers. Conceptually, the present invention allows a purchaser to complete a part of a purchase transaction in cyberspace, and a remainder of the transaction in real space. According to the present invention, electronic sales codes and corresponding electronic redemption codes are generated in response to an electronic commerce transaction between a purchaser and a vendor for a “good” (i.e., a good or service, e.g, goods, tickets, admittance to an event, hotel reservations, etc). The electronic redemption code is transmitted to an electronic storage device capable of storing the electronic redemption code, and the electronic sales code is transmitted to a server accessible to an electronic redemption device and is marked as valid. An electronic redemption device is located at a physical extension of the vendor (i.e., at a “real-world” store or forum where the good is available). The user may transport the electronic redemption code in the electronic storage device or transmit the electronic redemption code to another electronic storage device to facilitate transporting the electronic redemption code.

The electronic redemption device is capable of receiving the electronic redemption code from the purchaser in an electronic format. Preferably, the electronic redemption code is transmitted by a wireless, short-range transmission to the electronic redemption device, e.g. from an infra-red transmitter of a type now incorporated into many handheld PDA and Web-enabled cellular telephone devices. If the electronic redemption code is received at the electronic redemption device and corresponds to an electronic sales code marked as valid, the vendor will supply the purchaser with the purchased good.

### BRIEF DESCRIPTION OF THE DRAWINGS

FIG. 1A is a block diagram depicting than exemplary interrelationship between a purchaser, a vendor, and a purchasing system in accordance with the present invention;

FIG. 1B is a block diagram depicting an alternate interrelationship between a purchaser, a vendor, and a purchasing system in accordance with the present invention;

FIG. 2 is a flow diagram depicting logic of an electronic purchase from a purchaser's perspective in accordance with the present invention;

FIG. 3 is a flow diagram depicting logic of an electronic purchase from a vendor's perspective in accordance with the present invention;

FIG. 4 is a flow diagram depicting logic of an overview of an electronic purchase in accordance with the present invention;

FIG. 5A is a block diagram illustrating the purchase of a good or service in accordance with the present invention; and

FIG. 5B is a block diagram illustrating the purchase of admittance to a movie in accordance with the present invention.

### DESCRIPTION OF THE INVENTION

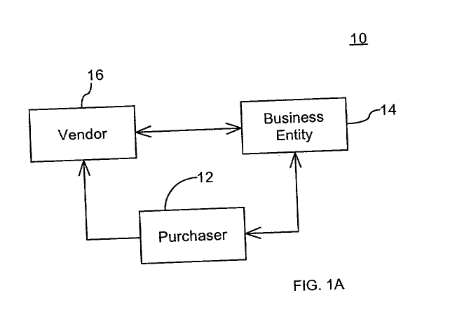

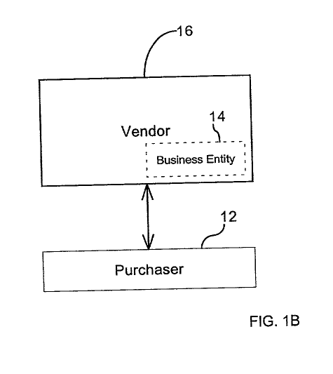

The block diagram 10 of FIG. 1A depicts an exemplary interrelationship between a purchaser, a vendor, and a business entity's purchasing system in accordance with the present invention. In block diagram 10, a purchaser 12 purchases goods from a vendor 16 utilizing the services of a business entity 14. For example, the purchaser 12 may be a potential movie patron and the vendor 16 may be a movie theater with the purchaser 12 attempting to purchase admission to a specific showing of a movie. In accordance with the present invention, the purchaser 12 communicates with an intermediary facility, such as an Internet-accessible website, referred to herein as the business entity 14. The business entity 14 operates a system for facilitating electronic commerce between the vendor 16 and the purchaser 12. Information such as pricing, scheduling, and availability may be communicated from the vendor 16 to the business entity 14, preferably electronically via a communications network such as the Internet. Alternatively, the business entity 14 may access such information stored on an Internet accessible server. A purchaser 12 accesses the business entity 14 to purchase goods or services from the vendor 16, preferably electronically via a communications network, e.g., by accessing and interacting with a website maintained by the business entity 14. Once the purchaser 12 makes a purchase, the business entity 14 generates an electronic redemption code that is transmitted to purchaser 12. The business entity also generates a corresponding electronic sales code that is transmitted to the vendor 16 and identified as valid. The vendor 16 stores such information for future reference. Purchaser 12 subsequently transmits the electronic redemption code to the vendor 16. The vendor 16 delivers the good and/or service to the purchaser 12 if a corresponding electronic sales code marked as valid is found. For example, in the movie theater example, the purchaser 12 is permitted to enter the theater. In an alternate embodiment, the business entity's system is at least partially incorporated directly into the vendor's operation as depicted in FIG. 1B.

The present invention may be incorporated into any electronic commerce system in which a prepayment or a reservation is made for a good or service. For example, the present invention may be used in, but is not limited to, the following: purchasing admission to restricted admission events such as movies, ball games, concerts, and operas; purchasing or reserving airline seats and/or hotel rooms; identifying entitlement at an all-inclusive resort; or purchasing goods, gifts, services, etc.

The financial aspects of the electronic commerce transactions can be handled in a multitude of ways which are well known in the art and are outside the scope of the present invention. Therefore, further discussion of the financial aspects of electronic commerce transactions is not warranted.

In addition, the electronic redemption code can be transmitted from the purchaser 12 to the vendor 16 via many different mediums, including, but not limited to, infrared, cellular transmission, radio waves, static memory devices, or any medium now used or developed in the future which may transmit a representation of an electronic code. These mediums are currently usable via existing electronic devices such as lap-top computers, personal digital assistants (PDAs), cellular telephones, etc. Adapting such devices for use with the present invention or developing similar devices is readily apparent to one skilled in the art.

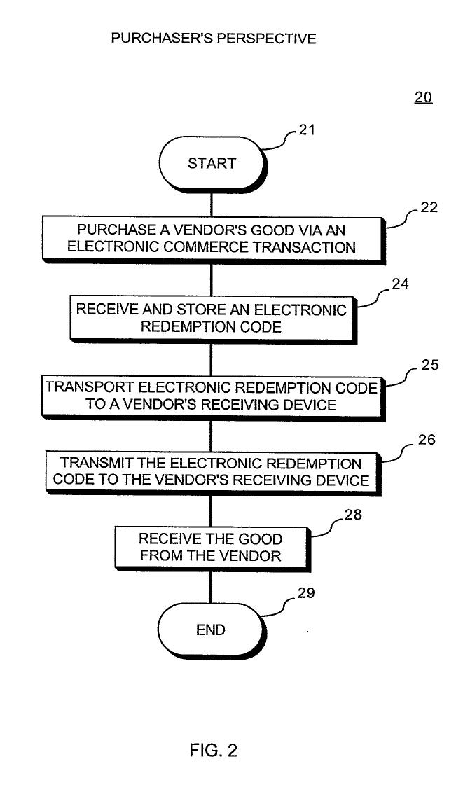

FIG. 2 is a flow diagram 20 depicting logic of an electronic purchase from a purchaser's perspective in accordance with the present invention. The flow diagram's representation of an electronic commerce transaction from a purchaser's perspective starts at step 21. In step 22, the purchaser purchases goods, wares, services, offerings, etc. (collectively referred to herein as a “good”) from a vendor via an electronic commerce transaction, e.g., via an online website purchase transaction. Online purchase transactions typically involve typing of a purchaser's credit card information into a web-based form presented by a vendor and are well known in the art. In this step, the purchaser does not receive the good. In effect, the purchaser is simply making an arrangement to receive the good in the future. In one embodiment, a credit card account is used for payment and the account is charged before step 26. In an alternate embodiment, the account is not charged until after step 26. The purchaser then receives an electronic redemption code in step 24. For example, the code may be transmitted via a communications network and stored electronically in a PDA by synchronizing the PDA with the computer via which step 22 is performed. The purchaser then transports the electronic redemption code to a physical extension, e.g., a “brick-and-mortar” store, of the vendor in step 25. For example, the purchaser may drive to the movie theater with his PDA storing the electronic redemption code. To claim the purchased good, the purchaser then transmits the electronic redemption code to a receiver at the vendor in step 26, e.g., by infra-red “beaming” of the electronic redemption code from his PDA to the vendor's receiving device. The receiving device may be an infrared port mounted in a kiosk at the vendor's brick and mortar store. The vendor then supplies the good to the purchaser in step 28. Step 29 signifies the end of the transaction.

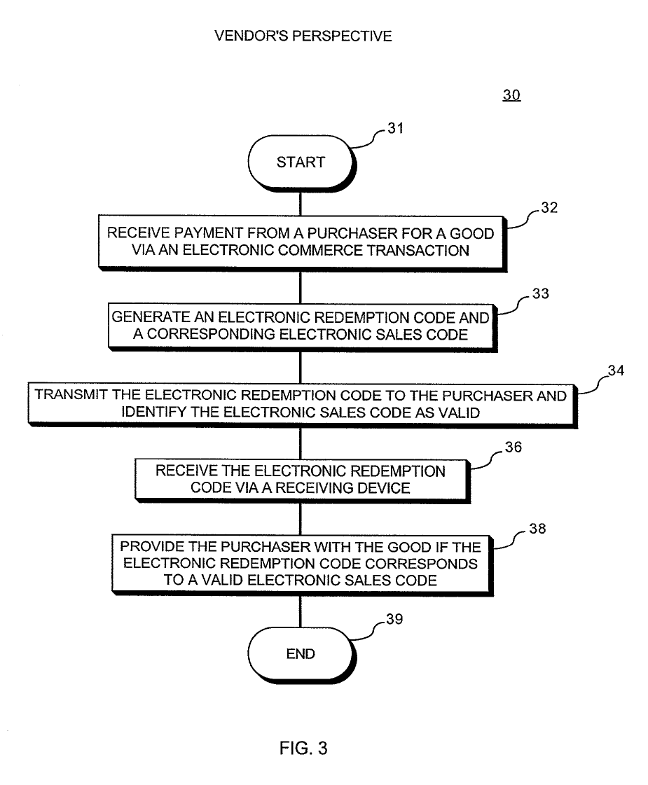

FIG. 3 is a flow diagram 30 depicting logic of an electronic purchase from a vendor's perspective in accordance with the present invention. The flow diagram's representation of an electronic commerce transaction from a vendor's perspective starts at step 31. In step 32, the vendor receives a payment or a reservation from a purchaser for a good via an electronic commerce transaction as described above. An electronic redemption code and a corresponding electronic sales code are generated in step 33. In step 34, the electronic redemption code is transmitted to an electronic storage device designated by the purchaser and the electronic sales code is stored and marked as valid. The vendor then receives the electronic redemption code at a physical extension of the vendor having access to the electronic sales code in step 36. The vendor then supplies the good to the purchaser if the electronic redemption code corresponds to a valid electronic sales code in step 38. Step 39 signifies the end of the transaction.

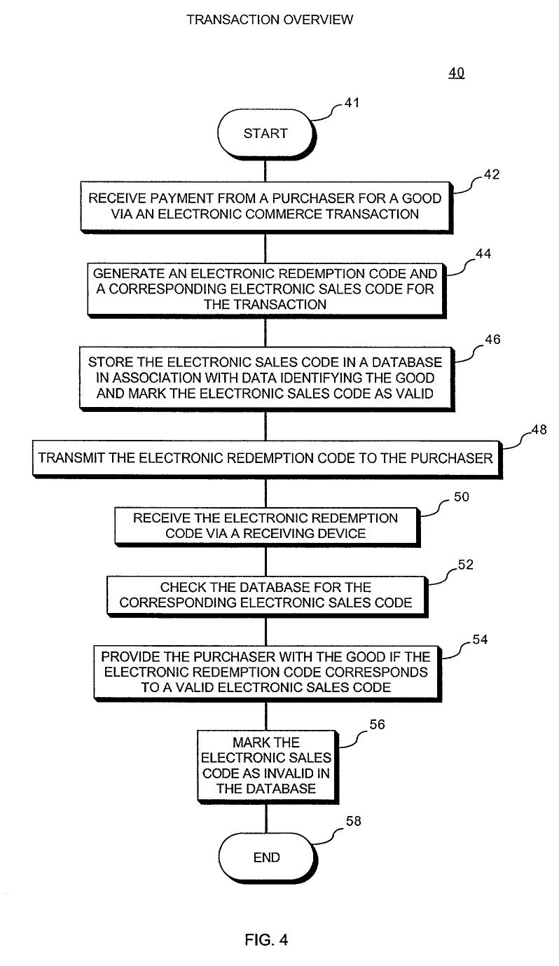

FIG. 4 depicts a flow diagram 40 of an electronic commerce transaction between a vendor and a purchaser. Step 41 indicates the start of a transaction. In step 42, a vendor receives a payment and/or a reservation from a purchaser for a good via an electronic commerce transaction. An electronic redemption code and a corresponding electronic sales code associated with the transaction are generated in step 44. The electronic sales code is stored in a database and identified as valid in step 46. In step 48, the electronic redemption code is transmitted to the purchaser. The electronic redemption code is then received by a receiving device from the purchaser in step 50. The receiving device is in communication with the database storing the electronic sales code such that codes received via the receiving device may be checked against codes stored in the database. The database is then checked for the corresponding electronic sales code in step 52. The purchaser is provided with the good in step 54 if the electronic redemption code corresponds to an electronic sales code marked as valid. The electronic sales code is identified as invalid after the purchaser receives the good in step 56. Alternatively, the electronic sales code is neither marked as valid nor invalid, but rather simply added to the database when a purchase is made and deleted from the database after the purchaser presents the redemption code and/or receives the good. Step 58 signifies the end of the transaction.

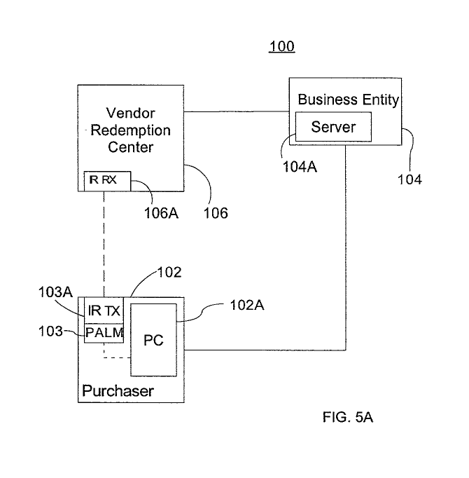

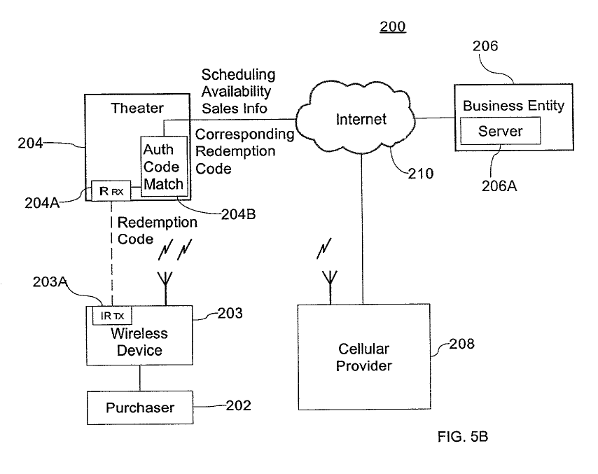

The block diagram 100 of FIG. 5A illustratively depicts one embodiment of the present invention. In this embodiment, a purchaser 102 is purchasing a good from a vendor. The purchaser 102 contacts a remote server 104A of a business entity 104 using a personal computer (PC) 102A. Information related to the good is available through the remote server 104A. Upon purchase of the good, the business entity 104 supplies the purchaser's PC 102A with an electronic redemption code generated by the server 104A. In addition, upon purchase, the business entity 104 supplies information corresponding to the redemption code to a vendor's redemption center 106. In the illustrated embodiment, the vendors redemption center 106 contains an infrared (IR) receive port 106A. The purchaser 102 transfers the redemption code to a handheld device 103, e.g., a PALM III™, with an IR transmit port 103A for portability. Handheld devices with IR transmit ports are well-known in the art. The purchaser 102 then takes the handheld device 103 to the vendor redemption center 106. The purchaser 102 redeems the purchased good from the vendor's redemption center 106 by transmitting the redemption code, via IR, from the IR transmit port 103A for reception by the IR receive port 106A. The vendor redemption center 106 then verifies the redemption code and, if verified as valid, supplies the purchaser 102 with the purchased good.

The block diagram 200 of FIG. 5B depicts yet another embodiment of the present invention in which a purchaser 202 desires access to a movie showing at a theater 204. The purchaser 202 accesses movie date and time information using a wireless device 203, e.g. a Web-enabled wireless telephone. In the illustrated embodiment, the movie date and time information is accessible through a remote server 206A located at a business entity 206, e.g. via a website. The purchaser 202 establishes contact with the remote server 206A through wireless communication via a cellular provider 208 and the Internet 210. After the purchaser 202 has identified the movie he would like to attend, the purchaser 202 produces purchasing information for purchasing admittance to the movie showing on the desired date at the desired time to the business entity 206. Upon purchasing admittance, the business entity supplies the purchaser 202 with a redemption code. In addition, upon purchase, the business entity 206 transfers information corresponding to the redemption code, e.g. a corresponding sales code, to the theater 204 via the Internet 210.

In the illustrated embodiment of FIG. 5B, the theater 204 contains an infrared (IR) receive port 204A and the purchaser's wireless device 203 contains an IR transmit port 203A. For example, wireless telephones having IR transmit ports are well known in the art. In order to obtain admittance to the desired movie, the purchaser 202 takes the wireless device 203 to the theater 204. The purchaser 202 gains admittance by transmitting the redemption code, via IR, from the IR transmit port 203A for reception by the IR receive port 204A. The theater 204 then verifies the redemption code using an authorization code match system 204B, e.g. a suitably configured personal computer running suitable software, and, if verified as valid, allows the purchaser 202 to enter the theater to see the desired movie. For example, the purchase could walk past a long line of movie-goers at a movie theater's ticket window, walk into the lobby, use his wireless PDA or telephone to purchase a ticket online, and immediately thereafter “beam” the electronic redemption code to the theater's receiving device and enter the theater, thereby bypassing the line at the ticket window.

The present invention finds particular utility in purchasing admission to shows and events. Especially to shows, events, and items which have are restricted access events, i.e. have limited seating availability and/or entry is controlled. For example, a purchaser of movie admissions and baseball game admissions would benefit from the present invention by being able to purchase tickets from home and avoid lines resulting from waiting for tickets at a “will-call” center at the stadium. Online ticket (and other goods) sellers can save costs of shipping/mailing the goods to the purchaser by eliminating such a step and instead electronically transmitting a redemption code to the purchaser at virtually no cost. In addition, a purchaser of a hard-to-find child's toy may purchase and reserve the toy at a store via the Internet and then redeem the toy at the “brick and-mortar” store, using the electronic redemption code, without worrying whether the toy will be at the store upon arrival. The invention avoids the delays and the need for printed tickets or receipts associated with prior art systems and methods.

Potential applications of the present invention include allowing a computer user to access movie information via the Internet at the business entity. The user purchases movie access and receives an electronic redemption code from the business entity. The user then electronically transmits the redemption code to a portable device with an infrared port, such as a PALM III™ computer. The user takes the portable device to the movie theater and transmits the redemption code to the movie theater's receiving device in order to be allowed admission to the theater. In this manner, the redemption code is maintained in electronic form. The user need not have a printer to print a ticket or redemption code indicia. Alternatively, the redemption code device could print a ticket for access to the theater.

Alternatively, a Web-enabled telephone with an infrared port could be used to access movie information via the Internet at the business entity. The user could purchase movie access and receive an electronic redemption code from the business entity. The user could then take the Web-enabled telephone to the movie theater and transmit the redemption code to the movie theater's receiving device and be allowed admission to the theater. Alternatively, the receiving device could print a ticket for access to the theater.

In another example, a wireless personal digital assistant (PDA) with an infrared port, such as a PALM VII™, could be used to access hotel information via the Internet. For example, such information may be available at the hotel's website. The user could make a reservation and receive an electronic redemption code from the business entity. The user could then take the wireless PDA to the hotel and transmit the electronic redemption code to the hotel's receiving device and be provided with access to a room.

In another example, a transportable electronic data storage device, such as a memory card, e.g., a SONY “memory stick”, is inserted in a device, such as a personal computer, for accessing a communications network, such as the Internet. Information for purchasing or reserving a good is transmitted via a communications network and an electronic redemption code is stored on the memory card. The memory card is physically transported to a redemption center, e.g., a brick and mortar store, and the electronic redemption code is read by a reader for reading electronic data, such as another personal computer, a memory reading device, a card swipe device, etc. The electronic redemption code is checked against an electronic sales code as described above.

In the above cited examples, the business entity facilitates purchases and reservations by acting as a clearing house between purchaser and vendors. However, alternative arrangements, such as incorporating the business entity into the vendor, or having the user access the vendor directly and the vendor interface with the business entity, or other similar arrangements, would be within the spirit and scope of the present invention. Accordingly, the business entity may act as a front end process for distributing goods information to purchasers and handling purchase transactions or may act as a back end process for process for handling purchase transactions after a purchaser shops at a seller's website. In addition, third parties could be incorporated into the method of the present invention. For example, web sites that specialize in ticketing could be interfaced with the present invention to offer electronic tickets at their site.

Having thus described a few particular embodiments of the invention, various alterations, modifications, and improvements will readily occur to those skilled in the art. For example, it will be readily apparent to those skilled in the art that the present invention can apply to ticket purchases, consumer goods purchases, services purchases, hotel room reservation, or essentially any transaction in which a prepayment or a reservation can be made. In addition, the system may be configured in many different ways, incorporating third parties and financial information in a variety of ways. Also, the system may be implemented through the use of the Internet, Internet II, local area networks, telephones (wireless and land-line), automatic teller machine, or essentially any communication means by which electronic data can be transmitted. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. An electronic purchasing method comprising the steps of:
generating an electronic redemption code and an electronic sales code which corresponds to said electronic redemption code in response to an electronic commerce transaction between a vendor and a purchaser for a good;
transmitting said electronic redemption code to an electronic device;
transmitting said electronic sales code to a vendor accessible server;
receiving said electronic redemption code from said electronic device at said vendor accessible server;
determining if said electronic sales code corresponds to said electronic redemption code; and
providing said purchaser with said good if said electronic sales code corresponds to said electronic redemption code.

2. The method of claim 1, wherein said electronic device is a static memory device.

3. The method of claim 1, wherein said electronic device is a cellular telephone.

4. The method of claim 1, wherein said electronic device is a personal digital assistant (PDA).

5. An electronic purchasing method comprising the steps of:
generating an electronic redemption code and an electronic sales code which corresponds to said electronic redemption code in response to an electronic commerce transaction between a vendor and a purchaser for a good;
transmitting said electronic redemption code to an electronic device;
transmitting said electronic sales code to a vendor accessible server;
identifying said electronic sales code as valid;
receiving said electronic redemption code from said electronic device at said vendor accessible server;
determining if said electronic sales code is valid and corresponds to said electronic redemption code;
providing said purchaser with said good if said electronic vendor code corresponds to said electronic redemption code and said electronic redemption code is valid; and
identifying said electronic sales code as invalid after said purchaser receives said goods.

6. The method of claim 5, wherein said good is an admission to an event.

7. The method of claim 6, wherein said electronic sales code is identified as invalid upon entry to said event and said electronic sales code is identified as valid upon exit of said event prior to the completion of said event.

8. The method of claim 7, wherein said event is a restricted access event.

9. The method of claim 5, wherein said transaction is the purchase of a good.

10. The method of claim 5, wherein said electronic device is a static memory device.

11. The method of claim 5, wherein said electronic device is a cellular telephone.

12. The method of claim 5, wherein said electronic device is a personal digital assistant (PDA).

13. An electronic purchasing method comprising the steps of:
generating an electronic redemption code in response to a transaction between a vendor and a purchaser;
transmitting said electronic redemption code to an electronic device designated by said purchaser for storage in said electronic device;
receiving said electronic redemption code from said electronic device at a physical extension of said vendor; and
completing said transaction in response to the receipt of said electronic redemption code at said physical extension of said vendor.

14. The method of claim 13, wherein said transaction is the purchase of one or more admissions to an event.

15. The method of claim 14, wherein said event is a restricted access event.

16. The method of claim 13, wherein said transaction is the purchase of a good.

17. An electronic purchasing system comprising:
a remotely accessible server accessible through a communication network, said remotely accessible server regulating transactions between vendors and purchasers, generating electronic redemption codes in response to said transactions, and transmitting said electronic redemption codes for storage by electronic devices designated by said purchasers; and
electronic vendor devices located at physical locations of said vendors, said electronic vendor devices being coupled to the remotely accessible server, receptive to said electronic redemption codes from the electronic devices, and confirming said transactions in response to the receipt of said electronic redemption codes.

18. The system of claim 17, wherein said electronic devices have wireless transmit capability and said electronic vendor devices have wireless receive capability, and wherein said electronic redemption code is transmitted from said electronic device to said electronic vendor device via a wireless communication medium supported by said electronic device and said electronic vendor device.

19. An electronic purchasing system comprising:
a remotely accessible server accessible through a communication network, said remotely accessible server regulating transactions between vendors and purchasers, generating electronic redemption codes in response to said transactions, and transmitting said electronic redemption codes for storage by electronic devices designated by said purchasers; and
a redemption center having an electronic redemption device capable of receiving said electronic redemption code coupled to said remotely accessible server, said redemption center completing said transactions in response to the receipt of said electronic redemption codes.

20. The system of claim 19, wherein said electronic devices have wireless transmit capability and said electronic redemption device has wireless receive capability, and wherein said electronic redemption code is transmitted from said electronic device to said electronic vendor device via a wireless communication medium supported by said electronic device and said electronic redemption device.

21. An electronic purchasing method comprising the steps of:
transmitting, responsive to a purchaser's purchase of a good, an electronic redemption code to an electronic device designated by said purchaser for storage in said electronic device;
receiving said electronic redemption code from said electronic device at a physical extension of a vendor; and
authorizing release of said good responsive to receipt of said electronic redemption code at said physical extension of said vendor.

22. The method of claim 21, further comprising the steps of:
determining whether said electronic redemption code corresponds to a purchase transaction and is therefore valid.

23. The method of claim 22, further comprising the step of: rendering said electronic redemption code invalid after said determining step.
